(19) United States
(12) Patent Application Publication
(10) Pub. No.: US 2025/0278359 A1
(43) Pub. Date: Sep. 4, 2025

(54) SOLID-STATE DRIVE CONTROLLER AND CONTROL METHOD THEREOF, SOLID-STATE DRIVE, AND SOLID-STATE DRIVE SYSTEM

(71) Applicant: DapuStor Corporation, Shenzhen (CN)

(72) Inventors: Yunxin HUANG, Shenzhen (CN); Haojun FANG, Shenzhen (CN)

(73) Assignee: DapuStor Corporation, Shenzhen (CN)

(21) Appl. No.: 19/210,230

(22) Filed: May 16, 2025

Related U.S. Application Data
(63) Continuation of application No. PCT/CN2023/094016, filed on May 12, 2023.

(30) Foreign Application Priority Data
Dec. 29, 2022 (CN) 202211711357.1

(51) Int. Cl. G06F 12/02; G06F 9/455

(52) U.S. Cl. CPC G06F 12/0246; G06F 9/45558; G06F 2009/45583; G06F 2212/7203; G06F 2212/7208

(57) ABSTRACT

A solid-state drive controller and control method thereof, a solid-state drive, and a solid-state drive system are provided. A solid-state drive controller includes a virtual machine, for running solid-state drive firmware; and a simulator connected to the virtual machine, for simulating at least one hardware module of the solid-state drive controller. When the solid-state drive firmware sends an access request to the hardware modules, the virtual machine intercepts the access request and sends the access request to the simulator so that the simulator simulates behaviors of the hardware modules.

### CROSS-REFERENCE TO RELATED APPLICATIONS

The present application is a continuation of International Application No. PCT/CN2023/094016, filed on May 12, 2023, which claims the benefit of priority to Chinese Patent Application No. 202211711357.1, filed on Dec. 29, 2022. The entire contents of each of the above-referenced applications are expressly incorporated herein by reference in their entirety.

### TECHNICAL FIELD

The present application relates to the field of solid-state drives, and in particular to a solid-state drive controller and control method thereof, a solid-state drive, and a solid-state drive system.

### BACKGROUND

Solid-state drives (SSD) are hard drives made of solid-state electronic storage chip arrays, consisting of a control unit and a storage unit (FLASH chip or DRAM chip).

At present, the software development of solid-state drives adopts a firmware development method based on multi-core and tightly coupled hardware and software. Among them, most of the software is developed by the original manufacturers of the main control chips, and then after long-term and large-scale rigorous testing of samples, it can reach the mass production and delivery standards, which involves a lot of manpower, material resources and testing costs. Once the software is modified in any way, a lot of testing has to be done all over again. Under this model, it is difficult for third parties to develop product-level software based on the main control chips from the original manufacturers. The mass production period of an enterprise-level SSD product software development is long, and the R&D cost is large. Therefore, most of the existing SSD products are developed by the original manufacturer of the main control chips, and the proportion of SSD manufacturers dedicated in independent software development is relatively small.

In addition, there is a large demand for SSD secondary development in the market. Under the current reality of SSD software and hardware architecture, it has to be entrusted to the original SSD manufacturer, resulting in high development costs and poor timeliness.

### SUMMARY

The embodiments of the present application provide a solid-state drive controller and control method thereof, a solid-state drive, and a solid-state drive system.

In a first aspect, embodiments of the present application provide a solid-state drive controller, including: a virtual machine, for running solid-state drive firmware; and a simulator connected to the virtual machine, for simulating at least one hardware module of the solid-state drive controller.

Here, when the solid-state drive firmware sends an access request to the hardware modules, the virtual machine intercepts the access request and sends the access request to the simulator so that the simulator simulates the behavior of the hardware modules.

In some embodiments, the solid-state drive controller includes multiple central processing units to support virtualization, and the multiple central processing units include multiple operating levels; and the virtual machine virtualizes multiple virtual central processing units for running the solid-state drive firmware.

In some embodiments, the solid-state drive firmware corresponds to an image file; and the simulator is configured to load the image file into the virtual central processing units so that the virtual central processing units run the solid-state drive firmware.

In some embodiments, the solid-state drive controller includes multiple hardware modules, the hardware modules include at least one of the peripheral component interconnect express (PCIe) module, the non-volatile memory express (NVMe) module, the buffer management module, the error correction code (ECC) module, and the NAND flash management module; and the simulator includes multiple virtual hardware modules, each virtual hardware module is configured to simulate a hardware module of the solid-state drive controller in a one-to-one correspondence, and the virtual hardware modules include at least one of a virtual PCIe module, a virtual NVMe module, a virtual buffer management module, a virtual ECC module, or a virtual NAND flash management module.

In some embodiments, the operation command is sent to the virtual machine through the virtual PCIe module.

In some embodiments, the virtual machine includes: a virtual machine monitor, for intercepting the access request sent by the solid-state drive firmware to the hardware modules.

In some embodiments, the solid-state drive controller further includes: an interrupt controller, connected to the central processing units of the solid-state drive controller for managing and controlling maskable interrupts, prioritizing maskable interrupts, and sending interrupt signals to the central processing units.

In a second aspect, embodiments of the present application provide a solid-state drive, including: the solid-state drive controller in the first aspect; and at least one NAND flash medium, communicatively connected to the solid-state drive controller.

In a third aspect, embodiments of the present application provide a solid-state drive system, including: the solid-state drive in the second aspect; and a host, communicatively connected to the solid-state drive.

In a fourth aspect, embodiments of the present application provide a control method for the solid-state drive controller, in which the solid-state drive controller in the first aspect is applied, including: generating a page fault exception if the data page accessed by an operation instruction does not exist in the memory when the virtual central processing units execute an operation instruction; intercepting the page fault exception and sending the page fault exception to the simulator by the virtual machine; and simulating the behavior of the hardware modules after the simulator receives the page fault exception.

In some embodiments, the page fault exception includes the memory page fault and the memory mapping page fault; for the memory page fault exception, the simulator maps the memory page to the virtual machine address to simulate the behavior of the hardware modules; for the memory mapping page fault exception, the simulator simulates the behavior of the hardware modules according to the type of the operation instruction, including: if the operation instruction is a read operation, the simulator feeds back read data to the virtual machine; and if the operation instruction is a write operation, the simulator simulates the behavior of the hardware modules on the write operation.

In a fifth aspect, embodiments of the present application further provide a non-volatile computer-readable storage medium; the computer-readable storage medium stores computer-executable instructions; the computer-executable instructions are configured to enable a solid-state drive to perform the control method for the solid-state drive controller.

The beneficial effects of embodiments of the present application are as follows: Different from the prior art, embodiments of the present application provide a solid-state drive controller, including: a virtual machine, for running solid-state drive firmware; and a simulator connected to the virtual machine, for simulating at least one hardware module of the solid-state drive controller; in which when the solid-state drive firmware sends an access request to the hardware modules, the virtual machine intercepts the access request and sends the access request to the simulator so that the simulator simulates the behavior of the hardware modules.

By providing a virtual machine in the solid-state drive controller to run the solid-state drive firmware, and a simulator to simulate the hardware modules of the solid-state drive controller, when the solid-state drive firmware sends an access request to the hardware modules, the virtual machine intercepts the access request and forwards it to the simulator to simulate the behavior of the hardware modules. On the one hand, by providing a virtual machine and a simulator in the solid-state drive controller, the software and hardware can be decoupled to realize the running of the solid-state drive firmware on the virtual machine to facilitate customized development of the solid-state drive. On the other hand, third parties can perform secondary development based on the simulator, thereby improving development efficiency.

### BRIEF DESCRIPTION OF DRAWINGS

One or more embodiments are exemplified by figures in the accompanying drawings, and these exemplary figures do not limit the embodiments. Elements with the same reference numerals in the drawings are denoted as similar elements, unless otherwise stated, and the figures in the drawings do not limit the scale.

FIG. 1 is a schematic diagram illustrating the structure of a solid-state drive according to embodiments of the present application.

FIG. 2 is a schematic diagram of a solid-state drive controller according to embodiments of the present application.

FIG. 3 is a schematic diagram illustrating the architecture of a solid-state drive controller according to embodiments of the present application.

FIG. 4 is a schematic diagram illustrating the structure of a solid-state drive controller according to embodiments of the present application.

FIG. 5 is a schematic diagram illustrating the structure of another solid-state drive controller according to embodiments of the present application.

FIG. 6 is a schematic diagram illustrating the software architecture of a virtualization hardware platform according to embodiments of the present application.

FIG. 7 is a schematic diagram illustrating the interaction between a simulator and a virtual machine according to embodiments of the present application.

FIG. 8 is a schematic diagram of a simulator according to embodiments of the present application.

FIG. 9 is a schematic flow chart of a control method for the solid-state drive controller according to embodiments of the present application.

FIG. 10 is a schematic diagram illustrating the structure of a solid-state drive system according to embodiments of the present application.

### DETAILED DESCRIPTION

In order to make the purpose, technical solutions, and advantages of the embodiments of the present application clearer, the technical solutions in the embodiments of the present application will be described below in conjunction with the accompanying drawings. Obviously, the described embodiments are part of the embodiments of the present application, not all embodiments. Based on the embodiments of the present application, all other embodiments obtained by ordinary skilled persons in the art without creative efforts are within the scope of protection of the present application.

In addition, the technical features involved in various embodiments of the present application described below can be combined with each other as long as they do not conflict with each other.

A typical solid-state drive (SSD) usually includes a solid-state drive controller (main controller), a NAND flash array, a cache unit, and other peripheral units.

The solid-state drive is usually controlled by a solid-state drive controller (SSD controller), which is used as a control operation unit to manage the internal system of the SSD; NAND flash array, as a storage unit, is configured to store data, including user data and system data. NAND flash array generally presents multiple channels (CH), and each channel is independently connected to a group of NAND flash, such as CH0/CH1 . . . . CHx. NAND flash has the characteristic that it must be erased before writing, and each NAND flash has a limited number of erases; cache unit is configured to cache mapping tables, and is generally dynamic random access memory (DRAM). Other peripheral units may include sensors, registers, and other components.

At present, the SSD main control architecture adopts a design and development method that tightly couples software with chip hardware. Customers and third parties usually need the original manufacturers of the main control chips for customized software development, resulting in high development costs and insufficient timeliness.

Based on this, the embodiments of the present application provide a solid-state drive controller and control method thereof, a solid-state drive, and a solid-state drive system to reduce development costs and improve development efficiency.

The technical solutions of embodiments of the present application are described below in conjunction with the drawings.

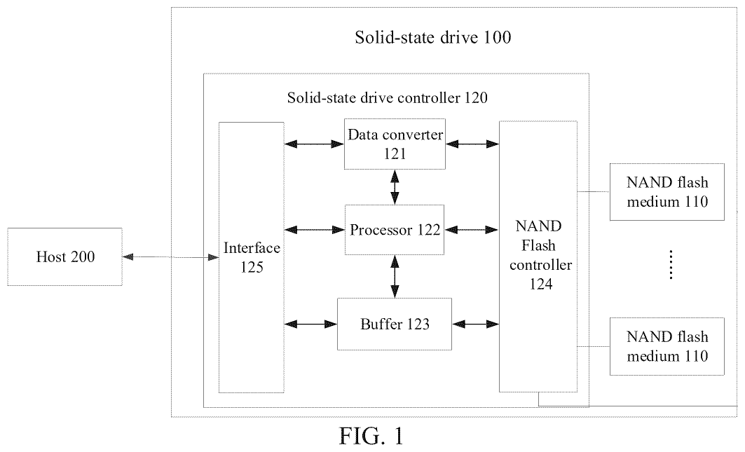

Referring to FIG. 1, which is a schematic diagram illustrating the structure of a solid-state drive according to embodiments of the present application.

As shown in FIG. 1, the solid-state drive 100 includes a NAND flash medium 110 and a solid-state drive controller 120 connected to the NAND flash medium 110. The solid-state drive 100 is communicatively connected with a host 200 in a wired or wireless manner to implement data interaction.

NAND flash medium 110, as a storage medium of the solid-state drive 100, is also called NAND flash, flash, flash memory, or flash particle; it belongs to memory devices and is a non-volatile memory that can store data for a long time even without current supply. Its storage characteristics are equivalent to those of hard disks, so that the NAND flash medium 110 can become the basis of storage media of various portable digital devices.

NAND flash medium 110 can be a NAND flash array, which is used as a storage unit to store user data and system data. NAND flash array generally presents multiple NAND flash channels (Channel, CH), and each channel is independently connected to a group of NAND flash. NAND flash uses a single transistor as a storage unit for binary signals. Its structure is very similar to that of ordinary semiconductor transistors. The difference is that the single transistor of NAND flash has additional floating gate and control gate. The floating gate is configured to store electrons, with its surface covered by a layer of silicon oxide insulator and coupled with the control gate through a capacitor. When negative electrons are injected into the floating gate under the action of the control gate, the storage state of the single crystal of NAND flash changes from “1” to “0”, and when the negative electrons are removed from the floating gate, the storage state changes from “0” to “1”. The insulator coated on the surface of the floating gate is configured to trap the negative electrons in the floating gate to achieve data storage. That is, the storage unit of NAND flash is a floating gate transistor, which is configured to store data in the form of charge. The amount of stored charge is related to the magnitude of the voltage applied to the floating gate transistor.

A NAND flash includes at least one chip, each of which is composed of several physical blocks, and each physical block includes several physical pages. Physical block is the smallest unit for NAND flash to perform erase operations, and the physical page is the smallest unit for NAND flash to perform read and write operations. The capacity of a NAND flash is equal to the number of its physical blocks*the number of physical pages contained in a physical block*the capacity of a physical page. The NAND flash medium 10 can be divided into SLC, MLC, TLC, and QLC according to different voltage levels of the storage unit.

The solid-state drive controller 120 includes a data converter 121, a processor 122, a buffer 123, a NAND flash controller 124, and an interface 125.

The data converter 121 is connected to the processor 122 and the NAND flash controller 124, respectively. The data converter 121 is configured to convert binary data into hexadecimal data and convert hexadecimal data into binary data. When the NAND flash controller 124 writes data into the NAND flash medium 110, binary data to be written is converted into hexadecimal data by the data converter 121 and then written into the NAND flash medium 110. When the NAND flash controller 124 reads data from the NAND flash medium 110, hexadecimal data stored in the NAND flash medium 110 is converted into binary data by the data converter 121 and then the converted data is read from a binary data page register. The data converter 121 may include a binary data register and a hexadecimal data register. The binary data register is configured to store the data converted from hexadecimal to binary, and the hexadecimal data register is configured to store the data converted from binary to hexadecimal.

The processor 122 is respectively connected with the data converter 121, the buffer 123, the NAND flash controller 124, and the interface 125, in which the processor 122 can be connected with the data converter 121, the buffer 123, the NAND flash controller 124, and the interface 125 through a bus or other means; the processor is configured to run non-volatile software programs, instructions, and modules stored in the buffer 123, thereby implementing any method embodiment of the present application.

The buffer 123 is mainly configured to buffer read/write instructions sent by the host 200 and read data or to-be-written data obtained from the NAND flash medium 110 according to the read/write instructions sent by the host 200. The buffer 123 is a non-volatile computer-readable storage medium that can be configured to store non-volatile software programs, non-volatile computer executable programs and modules. The buffer 123 may include a program storage area, which can store an operating system and application programs required for at least one function. In addition, the buffer 123 may include a high-speed random access memory, a non-volatile memory, such as at least one disk memory device, a NAND flash device, or other non-volatile solid-state memory devices. In some embodiments, the buffer 123 may include a memory remotely disposed relative to the processor 122. Examples of the above networks include but are not limited to the Internet, corporate intranets, local area networks, mobile communication networks, and combinations thereof. The buffer 123 can be a static random access memory (SRAM), a tightly coupled memory (TCM), or a double data rate synchronous dynamic random access memory (DDR SRAM).

The NAND flash controller 124 is connected to the NAND flash medium 110, the data converter 121, the processor 122, and the buffer 123 for processing communication protocols with the NAND flash, such as: accessing the NAND flash medium 110 at the back end, managing various parameters and data I/O of the NAND flash medium 110; or providing the interface and protocol for access to implement the corresponding SAS/SATA target protocol end or NVMe protocol end, obtain the I/O instructions issued by the host 200 and decode and generate internal private data results for execution.

The interface 125, connected to the host 200, the data converter 121, the processor 122, and the buffer 123, is configured to receive data sent by the host 200 or receive data sent by the processor 122 to facilitate data transmission between the host 200 and the processor 122; the interface 125 can be a SATA-2 interface, a SATA-3 interface, a SAS interface, an MSATA interface, a PCI-E interface, an NGFF interface, a CFast interface, an SFF-8639 interface, or an M.2 NVMe/SATA protocol.

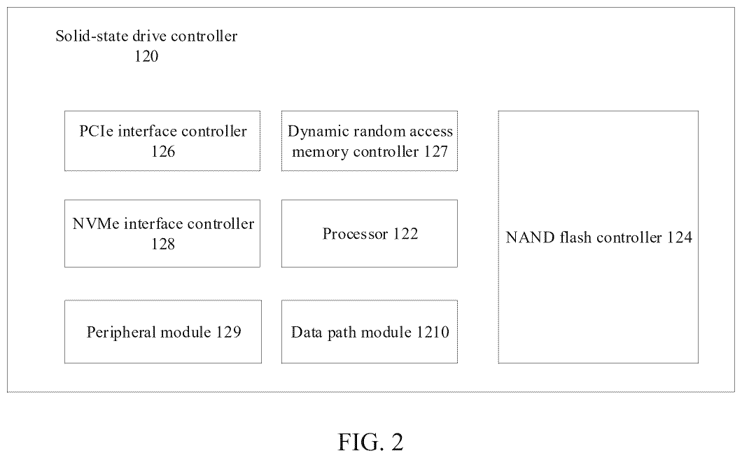

Referring further to FIG. 2, which is a schematic diagram illustrating the structure of a solid-state drive controller according to embodiments of the present application. The solid-state drive controller belongs to the above-mentioned solid-state drive.

As shown in FIG. 2, the solid-state drive controller includes: a PCIe interface controller 126, a dynamic random access memory controller 127, an NVMe interface controller 128, a processor 122, a peripheral module 129, a data path module 1210, and a NAND flash controller 124.

The host interface controller is configured to process the communication protocol with the host, including: a PCIe interface controller 126 and an NVMe interface controller 128.

In some embodiments, the PCIe interface controller 126 is configured to process the PCIe communication protocol with the host.

In some embodiments, the dynamic random access memory controller 127, namely the DDR controller, is configured to process and communicate with the dynamic random access memory protocol.

In some embodiments, the NVMe interface controller 128 is configured to process the NVMe communication protocol.

In some embodiments, the peripheral module 129 is configured to process other related communication protocols.

In some embodiments, the data path module 1210 is configured to control the data path and process internal data flows, such as: write cache management, and the NAND flash controller 124 is used for NAND flash data processing.

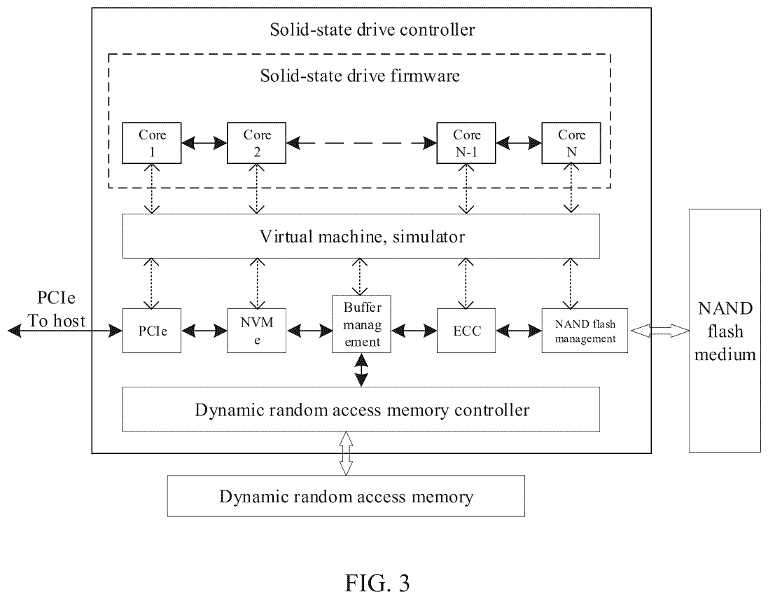

Referring further to FIG. 3, which is a schematic diagram illustrating the architecture of a solid-state drive controller according to embodiments of the present application.

As shown in FIG. 3, the solid-state drive controller includes a processor to run the solid-state drive firmware, which is responsible for scheduling the reading and writing of data from the interface end to the media end, and further includes a NAND flash medium life and reliability management scheduling algorithm embedded in the core, as well as some other SSD internal algorithms.

The processor includes N central processing units, namely CPU cores (Core), which are Core1-CoreN respectively. Multiple CPU cores constitute a software control path, and each CPU core corresponds to one or at least two hardware modules. It can be understood that the CPU cores and the hardware modules may have a one-to-one relationship, or a one-to-many or many-to-one relationship, which is not limited here.

The solid-state drive controller further includes multiple hardware modules, such as: the PCIe module, the NVMe module, the buffer management module, the ECC module, and the NAND flash management module.

In some embodiments, the Peripheral Component Interconnect Express (PCIe) module is configured to process the PCIe communication protocol with the host. PCIe is a standard protocol interface for communicating (data interaction) with the host. PCIe is a high-speed serial computer expansion bus standard. PCIe belongs to high-speed serial point-to-point multi-channel high-bandwidth transmission. The connected devices are allocated with exclusive channel bandwidth and do not share bus bandwidth. They mainly support functions such as active power management, error reporting, end-to-end reliable transmission, hot swapping, and quality of service (QOS).

In some embodiments, the NVMe module is configured to process the NVMe communication protocol with the host. NVMe is a communication protocol between the host and the solid-state drive (SSD). NVMe belongs to the upper layer in the protocol stack. As a command layer and application layer protocol, NVMe can theoretically be adapted to any interface protocol. However, PCIe is originally adapted to the NVMe protocol. NVMe specifies the commands for communication between the host and the SSD and how the commands are executed.

In some embodiments, the buffer management (BM) module is configured to manage the internal buffer of the solid-state drive.

In some embodiments, the ECC module is a data encoding and decoding unit for data encoding and decoding and ECC verification. It is understandable that since NAND flash memory inherently has a bit error rate, in order to ensure the correctness of data, ECC verification protection should be added to the original data during data writing operations. This is an encoding process. When reading data, error detection and correction are also required through decoding. If the number of erroneous bits exceeds the ECC error correction capability, the data will be uploaded to the host in an “uncorrectable” form. The ECC encoding and decoding process is completed by the ECC module.

In some embodiments, the NAND flash management module, namely the NAND flash controller, is configured to access the NAND flash medium and manage various parameters and data of the NAND flash medium.

It can be understood that hardware modules such as the PCIe module, the NVMe module, the buffer management module, the ECC module, and the NAND flash management module, constitute the data path of the solid-state drive controller, and the CPU core corresponding to the hardware modules constitutes the software control path, the software running on the CPU core is tightly coupled with the hardware modules to achieve the best performance. The software running on the CPU core is also called firmware.

However, the firmware development method based on multi-core and tightly coupled software and hardware is mostly developed and tested by the original manufacturers of the main control chips, resulting in high development costs and insufficient timeliness.

Therefore, the present application decouples the software from the hardware by providing a solid-state drive controller to reduce development costs and improve development efficiency.

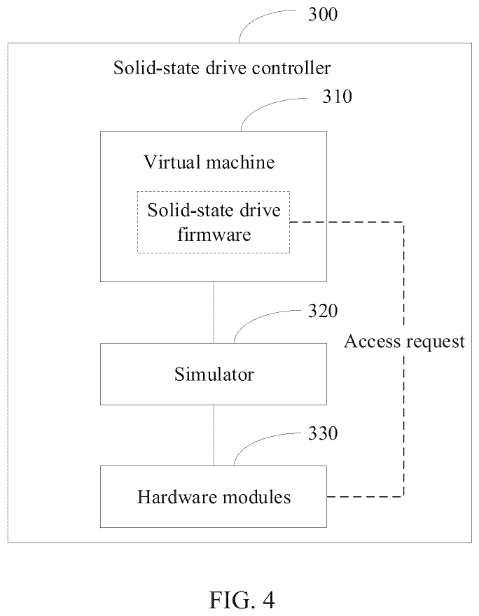

Referring further to FIG. 4, which is a schematic diagram illustrating the structure of a solid-state drive controller according to embodiments of the present application.

As shown in FIG. 4, the solid-state drive controller 300 includes: a virtual machine 310, a simulator 320, and hardware modules 330.

In embodiments of the present application, the virtual machine 310 is a kernel-based virtual machine (KVM), which is a kernel module of Linux that turns Linux into a Hypervisor.

In embodiments of the present application, the virtual machine 310 is configured to run a solid-state drive firmware. When the solid-state drive firmware accesses hardware, the access request of the solid-state drive firmware is intercepted by the virtual machine and transferred to the simulator 320, so that the simulator 320 partially or completely simulates the function of the hardware modules 330.

It can be understood that KVM is an open source Linux native full virtualization solution based on X86 hardware with virtualization extensions (Intel VT or AMD-V). In KVM, the virtual machine is implemented as regular Linux processes and scheduled by standard Linux schedulers; each virtual CPU of the virtual machine is implemented as a regular Linux process, which enables KVM to use the existing functions of the Linux kernel. However, KVM itself does not perform any hardware simulation, requiring applications to set up the address space of a client virtual server through the KVM interface and provide it with simulated I/O.

In embodiments of the present application, the simulator 320 is configured to simulate the function of at least one hardware module 330. The hardware modules to be simulated are divided into three types:
(1) Transparent transmission. In some embodiments, the simulator 320 transparently transmits the access request or operation command directly to the hardware modules 330 without any processing. At this time, the simulator acts as an intermediary.
(2) Full software simulation. In some embodiments, the simulator 320 simulates the function of the hardware modules 330, so that the simulator 320 can fully simulate the operation of the hardware modules 330 without passing an access request or an operation command to the hardware modules 330, that is, there is no need to call the hardware modules 330.
(3) Hybrid type. In some embodiments, the simulator 320 modifies the access request or operation command transmitted to the hardware modules 330, transmits the modified access request or operation command to the hardware modules 330, or obtains the command execution result of the hardware modules 330 and modifies the command execution result.

It can be understood that if the user needs to perform secondary development based on the simulator, for example: modifying the command execution results of NVMe, a hybrid approach is adopted. If the user does not need to conduct secondary development, the transparent transmission method is adopted. If the user needs to reuse the hardware modules used by the solid-state drive firmware, such as SPI flash, a full software simulation method is adopted.

In embodiments of the present application, the solid-state drive controller 300 includes multiple hardware modules, such as: the PCIe module, the NVMe module, the buffer management module, the ECC module, the NAND flash management module, and other hardware modules.

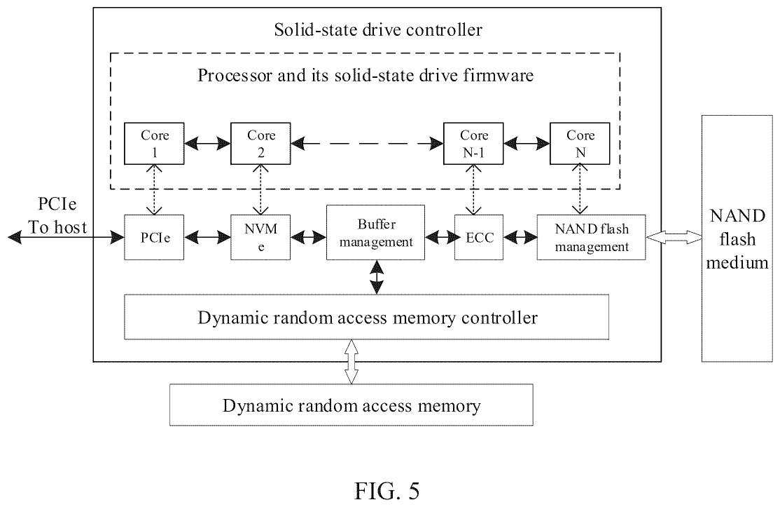

Referring further to FIG. 5, which is a schematic diagram illustrating the structure of another solid-state drive controller according to embodiments of the present application, in which the solid-state drive controller runs a Linux system.

As shown in FIG. 5, the solid-state drive controller includes: multiple central processing units (Core1-N), in which the solid-state drive firmware runs on the central processing units; a virtual machine (namely, a client system, including multiple virtual central processing units, memories, drivers, and so forth, in which the virtual machine is placed in a restricted CPU mode to run); a simulator; multiple hardware modules including, in some embodiments, the PCIe module, the NVMe module, the buffer management module, the ECC module, the NAND flash management module, and the dynamic random access memory controller, in which the NAND flash management module is configured to connect to the NAND flash medium; and the dynamic random access memory controller is configured to connect to the dynamic random access memory.

In order to realize the software customization of the solid-state drive, the solid-state drive controller in the embodiments of the present application decouples the software from the hardware, in which multiple central processing units support virtualization; and the solid-state drive firmware originally running in multiple central processing units runs in the form of a virtual machine.

By building a virtual machine in the solid-state drive controller, the solid-state drive firmware runs on the virtual machine, for example: Linux virtual machine. On this architecture, a simulator is further built to intervene in the execution process of the solid-state drive firmware, so that the customized functions required by the user can be realized based on the simulator, which can not only ensure the stability of the solid-state drive firmware, but also improve the flexibility of software development.

It should be noted that the solid-state drive controller in embodiments of the present application supports virtualization, including: CPU virtualization, memory virtualization, interrupt virtualization, I/O virtualization, network card virtualization, hard disk virtualization, and so forth.

CPU virtualization refers to multiple central processing units supporting multiple operating levels. For example: the central processing units in the solid-state drive controller use an ARM V8 architecture CPU to support four operating levels of EL0˜EL3.

Memory virtualization refers to the access of software running on a virtual machine to memory which must be intercepted by the Hypervisor. Hypervisor is an intermediate software layer running between the underlying physical server and the operating system, allowing multiple operating systems and applications to share hardware. Hypervisor is also called a virtual machine monitor (VMM). Hypervisor is a “meta” operating system in a virtual environment. It accesses all physical devices on the server, including disk and memory.

In embodiments of the present application, the solid-state drive controller further includes:
a memory management unit for processing the memory access request of central processing units of the solid-state drive controller. The memory management unit (MMU) is configured to process memory access requests from the central processing unit (CPU), such as: conversion of virtual addresses to physical addresses (i.e. virtual memory management), memory protection, and control of CPU cache. In embodiments of the present application, the memory management unit converts the virtual address where the program is running into the actual physical address in the form of a page table. In virtual machine mode, the page table of the memory management unit completes two address conversions in one query, one is to convert the virtual address of the client program into the physical address of the client, and the other is to convert the physical address of the client into a real physical address.

Interrupt virtualization refers to the processing of interrupt events through an interrupt controller. In embodiments of the present application, the solid-state drive controller includes: an interrupt controller, connected to the central processing units of the solid-state drive controller for managing and controlling maskable interrupts, prioritizing maskable interrupts, and sending interrupt signals to the central processing units.

It can be understood that the interrupt controller is equivalent to an agent. Interrupt events generated by external devices do not enter the central processing units directly, but are sent to the interrupt controller, which forwards the interrupt event to the central processing units. The interrupt controller is configured to manage interrupt triggering conditions, and real systems may have hundreds or thousands of interrupt sources. The premise for running a virtual machine is that the interrupt controller of the host has the function of interrupt injection, that is, the software injects hardware interrupts into the client (the virtual machine), which is equivalent to an interrupt agent. The virtual machine does not perceive that the interrupt is injected by the host software.

I/O virtualization refers to the access of client virtual machines to hardware, such as I/O or MMIO access, which must be intercepted by the virtual machine monitor (Hypervisor) and implemented through page faults in the memory management unit (MMU).

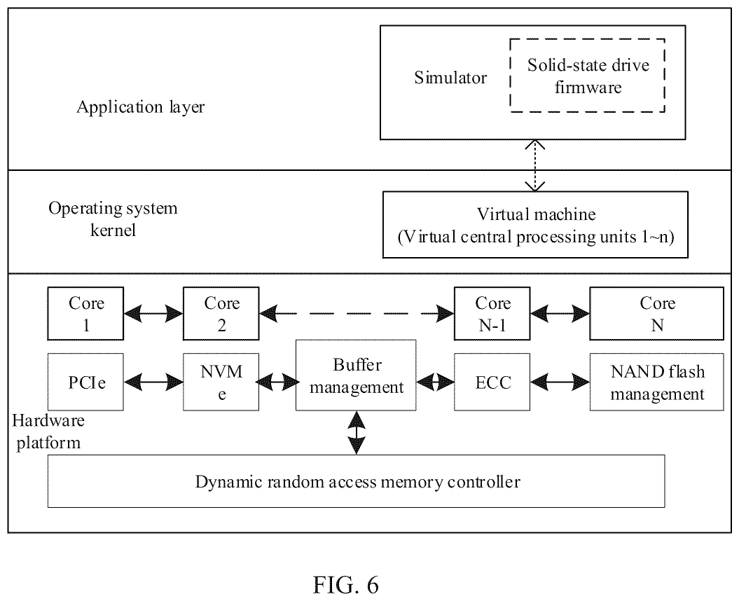

Referring further to FIG. 6, which is a schematic diagram illustrating the software architecture of a virtualization hardware platform according to embodiments of the present application.

As shown in FIG. 6, the software architecture includes an operating system kernel and an application layer.

The operating system kernel includes a Linux kernel layer, and the present application layer includes a Linux Application.

The virtual machine runs on the operating system kernel, for example: running on the Linux kernel, and the virtual machine running on the operating system kernel is configured to virtualize multiple virtual central processing units so that the virtual central processing units can run solid-state drive firmware. For example: the virtual machine virtualizes multiple virtual central processing units, namely vCPU1˜vCPUn, and the number of virtual central processing units of the virtual machine is consistent with the number of the central processing units of the solid-state drive controller. It can be understood that the virtual machine further provides memory virtualization, interrupt virtualization, I/O virtualization, and so forth. The virtual machine generates a corresponding file handle for each virtual central processing unit (vCPU), and calls the file handle accordingly, so that each virtual central processing unit can be managed.

The simulator runs as an application at the present application layer, for example: Linux Application. The simulator is configured to load the image file corresponding to the solid-state drive firmware into the virtual central processing unit of the virtual machine for operation.

When the I/O request of the solid-state drive firmware is intercepted by the virtual machine, the virtual machine hands over the I/O request to the simulator for processing.

In embodiments of the present application, the solid-state drive firmware corresponds to an image file, which can be a binary file. It can be understood that firmware files are usually encapsulated in file compression types such as bin, zip, LZMA, arj. Among them, the most common ones are bin and zip. Bin files are in the form of binary images. Bin files are the most direct code images. The content they record is the binary data to be stored in flash (machine code is essentially binary data). Binary files do not store data in ASCII codes. They transfer the data storage form in memory to a disk file without conversion, so it is also called an image file of memory data. Because the information in a file is not character data, but binary information in bytes, it is also called a byte file.

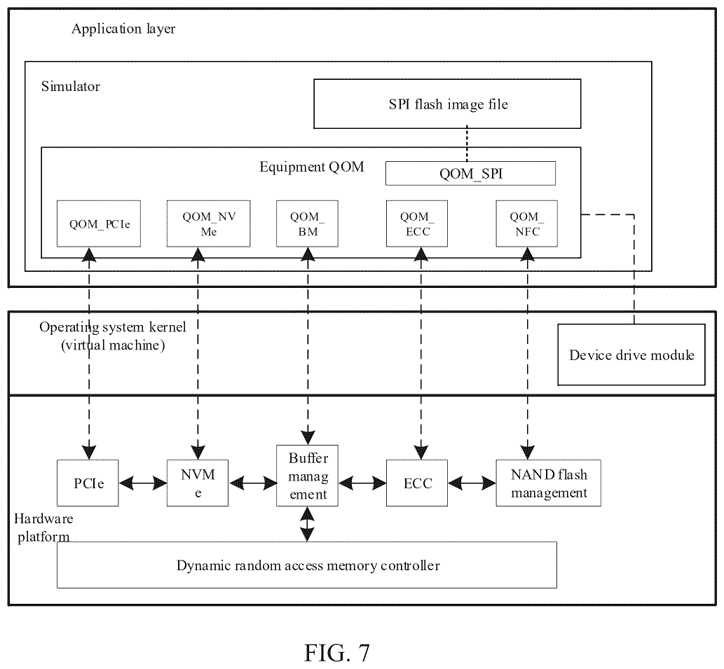

Referring further to FIG. 7, which is a schematic diagram illustrating the interaction between a simulator and a virtual machine according to embodiments of the present application.

As shown in FIG. 7, the solid-state drive controller includes multiple hardware modules, the hardware modules include at least one of a PCIe module, an NVMe module, a buffer management module, an ECC module, or a NAND flash management module; and the simulator includes multiple virtual hardware modules, each virtual hardware module is configured to simulate a hardware module of the solid-state drive controller in a one-to-one correspondence, and the virtual hardware modules include at least one of a virtual PCIe module, a virtual NVMe module, a virtual buffer management module, a virtual ECC module, and a virtual NAND flash management module.

Each hardware module in the solid-state drive controller corresponds to a virtual hardware module, which is simulated by a simulator. For example, as shown in FIG. 7, the PCIe module corresponds to the virtual PCIe module (QOM_PCIe), the NVMe module corresponds to the virtual NVMe module (QOM_NVMe), the buffer management module corresponds to the virtual buffer management module (QOM_BM), the ECC module corresponds to the virtual ECC module (QOM_ECC), and the NAND flash management module corresponds to the virtual NAND flash management module (QOM_NFC).

In embodiments of the present application, each virtual hardware module is implemented by an object-oriented programming interface. In some embodiments, each virtual hardware module is written in QOM under the QEMU environment. Qemu Object Model (QOM) is an object-oriented programming model implemented by Qemu. Qemu is written in C language, which is a process-oriented programming language and cannot enjoy the superiority of object-oriented programming mode over design patterns for complex software systems. To solve this problem, the Qemu community implemented a set of object-oriented programming interfaces, namely QOM, in C language and successfully applied it to the management of Qemu device models. QOM is a set of programming interfaces for creating “classes” and “objects”. The interface supports the user to create types and instantiate objects based on the classes. It has the following characteristics: support dynamic registration and creation of classes; support single inheritance of classes (only one parent class); and support multiple inheritance of classes.

In embodiments of the present application, each hardware module in the hardware platform of the solid-state drive controller has a corresponding QOM software module in the QEMU simulator, such as the QOM_PCIe, the QOM_NVMe, and the QOM_BM. The solid-state drive firmware is stored in a Linux file and transferred to the virtual machine via the virtual bus module (QOM_SPI). When the virtual machine accesses the SPI address, after being intercepted by the virtual machine (KVM), it calls the response function of the QEMU simulator, that is, the virtual bus module (QOM_SPI), and then QOM_SPI forwards the SPI flash image file to the virtual machine, so that the virtual machine obtains the SPI flash image file, and the SPI flash image file includes the image file of the solid-state drive firmware. It can be understood that SPI is the abbreviation of serial peripheral interface, which is a high-speed, full-duplex, and synchronous communication bus.

It can be understood that each hardware module can correspond to a virtual hardware module of the simulator to realize the simulation of the hardware modules.

If the user does not need to conduct any secondary development, the user only needs to connect the virtual machine operation directly to the hardware modules in the virtual hardware modules corresponding to the hardware modules. For example: if the virtual machine wants to write the NVMe register, the operation of the virtual NVMe module (QOM_NVMe) is to send the write operation directly to the NVMe module without other processing.

If the user wants to modify the command execution result of the solid-state drive firmware for secondary development, the virtual NVMe module can modify the data of the write operation and send it to the NVMe module, or modify the original execution result of the virtual machine in memory before notifying the NVMe module.

It can be understood that in a simple SSD application, PCIe acts as a slave device (PCIe Endpoint), and the QOM of each hardware module of QEMU is usually directly connected to the physical hardware module (such as the PCIe hardware module), and can also inject behaviors that need to be customized. For example, secondary development requires modifying the content of NVMe identify. For example: the version number of the NVMe protocol can be intercepted by KVM/QEMU when the virtual machine prepares the identify content and submits it to the hardware modules for transmission to the host. Then the user can modify the identify content and submit it to the hardware modules for transmission to the host.

In the present application scenarios of integrated storage and computing, such as some data recording or other edge computing applications, PCIe is used as the root port, and the PCIe hardware module is no longer in Endpoint mode. The endpoint refers to the terminal, which is configured to provide a human-machine interface for the host. Everyone uses the host's resources through the terminal. Therefore, QEMU's PCIe QOM and hardware PCIe modules are no longer in pass-through mode. At this time, the virtual NVMe module (QOM_NVMe) is used as a virtual device, and the local Linux system can access the local Flash storage at high speed through the virtual PCIe interface, for example: inject NVMe commands from the virtual PCIe interface.

In the present application scenario of computational storage drive (CSD), the original SSD function is completely retained. At this time, the PCIe module is still used as a terminal, and a local system access path needs to be added to realize the calculation acceleration function for local flash data. At this time, it is achieved by adding a virtual PCIe interface on the virtual NVMe module (QOM_NVMe).

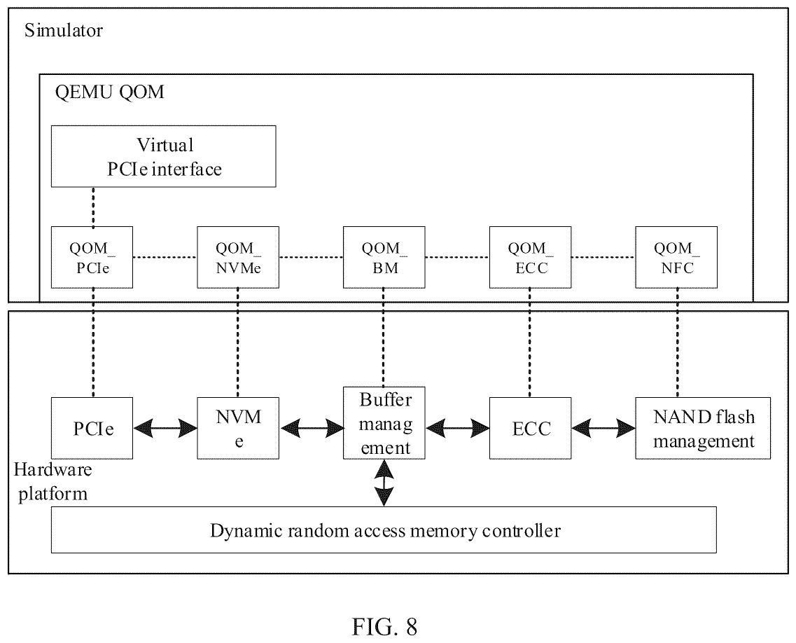

Referring further to FIG. 8, which is a schematic diagram of a simulator according to embodiments of the present application.

As shown in FIG. 8, the NVMe module corresponds to two PCIe interfaces, one from the host-side PCIe interface and the other from the local PCIe interface virtualized by the virtual PCIe module (QOM_PCIe).

Embodiments of the present application provide a solid-state drive controller, including: a virtual machine, for running solid-state drive firmware; and a simulator connected to the virtual machine, for simulating at least one hardware module of the solid-state drive controller, in which when the solid-state drive firmware sends an access request to the hardware modules, the virtual machine intercepts the access request and sends the access request to the simulator so that the simulator simulates the behavior of the hardware modules.

By providing a virtual machine in the solid-state drive controller to run the solid-state drive firmware, and a simulator to simulate the hardware modules of the solid-state drive controller, when the solid-state drive firmware sends an access request to the hardware modules, the virtual machine intercepts the access request and forwards it to the simulator to simulate the behavior of the hardware modules. On the one hand, by providing a virtual machine and a simulator in the solid-state drive controller, the software and hardware can be decoupled to realize the running of the solid-state drive firmware on the virtual machine to facilitate customized development of the solid-state drive. On the other hand, third parties can perform secondary development based on the simulator, thereby improving development efficiency.

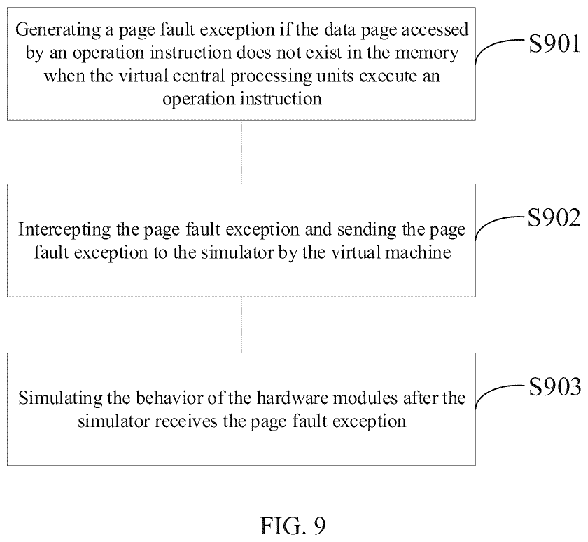

Referring further to FIG. 9, which is a schematic flow chart of a control method for the solid-state drive controller according to embodiments of the present application.

The control method of the solid-state drive controller is applied to the solid-state drive controller mentioned in the above embodiments, and the solid-state drive controller includes a virtual machine, a simulator, and at least one hardware module.

As shown in FIG. 9, the flow of the control method for the solid-state drive controller includes three steps.

At S901, generate a page fault exception if the data page accessed by an operation instruction does not exist in the memory when the virtual central processing units execute an operation instruction.

When the virtual central processing unit executes an operation instruction, such as an I/O operation, if the data page accessed by the operation instruction does not exist in the memory, for example: the page table entry existence bit of the virtual page is 0, then the virtual central processing unit generates an interrupt that the page does not exist, that is, a page fault exception is generated to trigger the page fault interrupt handling function.

It can be understood that accessing a non-existent page will trigger a page fault exception. At this time, the central processing unit (CPU) of the solid-state drive controller enters a higher level of operation, such as from EL1, EL2 to EL3, which is equivalent to the operation being taken over by the host and the virtual machine being suspended.

At S902, the virtual machine intercepts the page fault exception and sends it to the simulator.

When the virtual machine intercepts a page fault exception, it processes the page fault exception, prepares the memory, fills the address mapping relationship into the table entry of the memory management unit (MMU) of the virtual machine process, and then returns to the virtual machine to continue running, and sends the page fault exception to the simulator.

It can be understood that the central processing unit (CPU) of the solid-state drive controller provides hardware support for interception and redirection of special instructions, and even new hardware will provide additional resources to help software virtualize key hardware resources to improve performance. The central processing unit (CPU) supports virtualization technology and controls the virtualization process with a specially optimized instruction set. Through these instruction sets, the virtual machine monitor (VMM) puts the client into a restricted mode of operation. Once the client tries to access physical resources, the hardware will suspend the client's operation and return control to the virtual machine monitor for processing.

The virtual machine monitor can also use the hardware's virtualization enhancement mechanism to completely redirect the client's access to some specific resources in a restricted mode from the hardware to the specified virtual resources.

It can be understood that the virtual machine is loaded into the kernel space on demand when running. The virtual machine itself does not perform any device simulation.

At S903, simulate the behavior of the hardware modules after the simulator receives the page fault exception.

In some embodiments, the page fault exception includes the memory page fault and the memory mapping page fault. For the memory page fault exception, the simulator maps the memory page to the virtual machine address to simulate the behavior of the hardware modules; for the memory mapping page fault exception, the simulator simulates the behavior of the hardware modules according to the type of the operation instruction, including: if the operation instruction is a read operation, the simulator feeds back read data to the virtual machine; and if the operation instruction is a write operation, the simulator simulates the behavior of the hardware modules on the write operation.

In some embodiments, simulating the behavior of the hardware modules: sending the operation instruction directly to the hardware modules; or fully simulating the behavior of the hardware modules by a simulator; or modifying the operation instruction or the command execution result of the hardware modules.

For example: the hardware modules to be simulated are divided into three types:
(1) Transparent transmission. In some embodiments, the simulator transparently transmits the access request or operation command directly to the hardware modules without any processing. At this time, the simulator acts as an intermediary.
(2) Full software simulation. In some embodiments, the simulator completely simulates the function of the hardware modules, so that the simulator can fully simulate the operation of the hardware modules without passing an access request or an operation command to the hardware modules, that is, there is no need to call the hardware modules.
(3) Hybrid type. In some embodiments, the simulator modifies the access request or operation command transmitted to the hardware modules, transmits the modified access request or operation command to the hardware modules, or obtains the command execution result of the hardware modules and modifies the command execution result.

It can be understood that if the user needs to perform secondary development based on the simulator, for example: modifying the command execution results of NVMe, a hybrid approach is adopted. If the user does not need to conduct secondary development, the transparent transmission method is adopted. If the user needs to reuse the hardware modules used by the solid-state drive firmware, such as SPI flash, a full software simulation method is adopted.

In embodiments of the present application, a control method for the solid-state drive controller is provided and applied to the solid-state drive controller of the above embodiments. The method includes: generating a page fault exception if the data page accessed by an operation instruction does not exist in the memory when the virtual central processing units execute an operation instruction; intercepting the page fault exception and sending the page fault exception to the simulator by the virtual machine; and simulating the behavior of the hardware modules after the simulator receives the page fault exception.

The virtual central processing units of the virtual machine execute the operation instruction, the virtual machine intercepts the page fault exception, and uses the simulator to simulate the behavior of the hardware modules, so that a third party can perform secondary development based on the simulator and improve development efficiency.

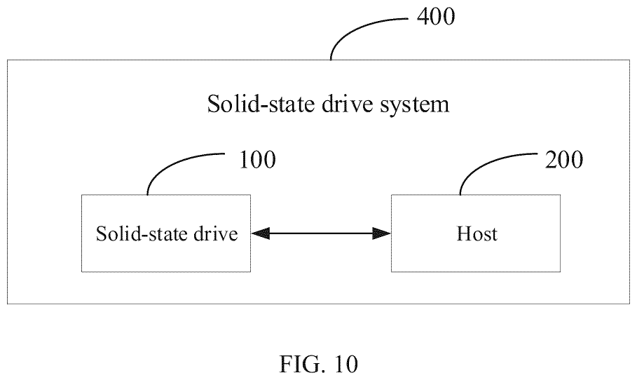

Embodiments of the present application further provide a solid-state drive system. Referring to FIG. 10, which is a schematic diagram illustrating the structure of a solid-state drive system according to embodiments of the present application.

As shown in FIG. 10, the solid-state drive system 400 includes: a solid-state drive 100 and a host 200.

It should be noted that the relevant content of the solid-state drive 100 can refer to the content mentioned in the above embodiments, and will not be repeated here.

The host 200 is communicatively connected to the solid-state drive 100. For example: the solid-state drive controller communicates with the host through a host interface processor, which is configured to process the communication protocol with the host.

The solid-state drive controller also communicates with the host 200 through the PCIe interface. For example, in an integrated storage and computing application scenario, the PCIe interface is used as a root port, and the simulator in the solid-state drive controller accesses the local flash memory at high speed through the virtual PCIe module.

Embodiments of the present application further provide a non-volatile computer storage medium, which stores computer executable instructions. The computer executable instructions are executed by one or more processors. For example, the one or more processors can execute the control method of the solid-state drive controller in any of the above method embodiments.

The device or equipment implementation examples described above are only illustrative. The unit modules described as separate components may or may not be physically separated. The components displayed as module units may or may not be physical units, that is, they can be located in one place or distributed to multiple network module units. Some or all of the modules can be selected according to actual needs to achieve the purpose of the embodiment.

Through the description of the above implementation methods, those skilled in the art can clearly understand that each implementation method can be implemented by software plus a general hardware platform, or by hardware. Based on this understanding, the above technical solution essentially or the part that contributes to the relevant technology can be embodied in the form of a software product, which can be stored in a computer-readable storage medium such as ROM/RAM, magnetic disk, optical disk, etc., including several instructions used until a computer device (which can be a personal computer, server, or network device, etc.) executes various embodiments or certain parts of the embodiments.

It should be noted that the above embodiments are only used to illustrate the technical solutions of the present application, and not to limit them; under the idea of the present application, the technical features of the above embodiments or different embodiments can also be combined, and the steps can be implemented in any order, and there are many other changes in different aspects of the present application as described above. Although the present application has been described in detail with reference to the foregoing embodiments, those of ordinary skill in the art should understand that: it can still modify the technical solutions described in the foregoing embodiments, or equivalently replace some of the technical features; and these modifications or substitutions do not make the essence of the corresponding technical solutions depart from the scope of the technical solutions of the embodiments of the present application.

1. A solid-state drive controller, comprising:
a virtual machine, for running solid-state drive firmware; and
a simulator connected to the virtual machine, for simulating at least one hardware module of the solid-state drive controller,
wherein when the solid-state drive firmware sends an access request to the hardware modules, the virtual machine intercepts the access request and sends the access request to the simulator so that the simulator simulates behaviors of the hardware modules.

2. The solid-state drive controller according to claim 1, wherein:
the solid-state drive controller comprises multiple central processing units to support virtualization, and the multiple central processing units include multiple operating levels; and
the virtual machine virtualizes multiple virtual central processing units for running the solid-state drive firmware.

3. The solid-state drive controller according to claim 2, wherein:
the solid-state drive firmware corresponds to an image file; and
the simulator is configured to load the image file into the virtual central processing units so that the virtual central processing units run the solid-state drive firmware.

4. The solid-state drive controller according to claim 1, wherein:
the solid-state drive controller comprises multiple hardware modules, the hardware modules include at least one of a peripheral component interconnect express (PCIe) module, a non-volatile memory express (NVMe) module, a buffer management module, an error correction code (ECC) module, or a NAND flash management module; and
the simulator comprises multiple virtual hardware modules, each virtual hardware module is configured to simulate a hardware module of the solid-state drive controller in a one-to-one correspondence, and the virtual hardware modules include at least one of a virtual PCIe module, a virtual NVMe module, a virtual buffer management module, a virtual ECC module, or a virtual NAND flash management module.

5. The solid-state drive controller according to claim 4, wherein an operation command is sent to the virtual machine through the virtual PCIe module.

6. The solid-state drive controller according to claim 1, wherein the virtual machine comprises:
a virtual machine monitor, for intercepting the access request sent by the solid-state drive firmware to the hardware modules.

7. The solid-state drive controller according to claim 1, wherein the solid-state drive controller further comprises:
an interrupt controller, connected to central processing units of the solid-state drive controller for managing and controlling maskable interrupts, prioritizing maskable interrupts, and sending interrupt signals to the central processing units.

8. A solid-state drive, comprising: a solid-state drive controller; and at least one NAND flash medium, communicatively connected to the solid-state drive controller,
wherein the solid-state drive controller comprises:
a virtual machine, for running solid-state drive firmware; and
a simulator connected to the virtual machine, for simulating at least one hardware module of the solid-state drive controller,
wherein when the solid-state drive firmware sends an access request to the hardware modules, the virtual machine intercepts the access request and sends the access request to the simulator so that the simulator simulates behaviors of the hardware modules.

9. The solid-state drive according to claim 8, wherein:
the solid-state drive controller comprises multiple central processing units to support virtualization, and the multiple central processing units include multiple operating levels; and
the virtual machine virtualizes multiple virtual central processing units for running the solid-state drive firmware.

10. The solid-state drive according to claim 9, wherein:
the solid-state drive firmware corresponds to an image file; and
the simulator is configured to load the image file into the virtual central processing units so that the virtual central processing units run the solid-state drive firmware.

11. The solid-state drive according to claim 8, wherein:
the solid-state drive controller comprises multiple hardware modules, the hardware modules include at least one of a peripheral component interconnect express (PCIe) module, a non-volatile memory express (NVMe) module, a buffer management module, an error correction code (ECC) module, or a NAND flash management module; and
the simulator comprises multiple virtual hardware modules, each virtual hardware module is configured to simulate a hardware module of the solid-state drive controller in a one-to-one correspondence, and the virtual hardware modules include at least one of a virtual PCIe module, a virtual NVMe module, a virtual buffer management module, a virtual ECC module, or a virtual NAND flash management module.

12. The solid-state drive according to claim 11, wherein an operation command is sent to the virtual machine through the virtual PCIe module.

13. The solid-state drive according to claim 8, wherein the virtual machine comprises:
a virtual machine monitor, for intercepting the access request sent by the solid-state drive firmware to the hardware modules.

14. The solid-state drive according to claim 8, wherein the solid-state drive controller further comprises:
an interrupt controller, connected to central processing units of the solid-state drive controller for managing and controlling maskable interrupts, prioritizing maskable interrupts, and sending interrupt signals to the central processing units.

15. A control method performed by a solid-state drive controller, wherein the solid-state drive controller comprises:
a virtual machine, for running solid-state drive firmware; and
a simulator connected to the virtual machine, for simulating at least one hardware module of the solid-state drive controller,
wherein when the solid-state drive firmware sends an access request to the hardware modules, the virtual machine intercepts the access request and sends the access request to the simulator so that the simulator simulates behaviors of the hardware modules,
wherein the control method comprises:
generating a page fault exception if a data page accessed by an operation instruction does not exist in a memory when virtual central processing units execute an operation instruction;
intercepting the page fault exception and sending the page fault exception to the simulator by the virtual machine; and
simulating behaviors of the hardware modules after the simulator receives the page fault exception.

16. The control method according to claim 15, wherein:
the page fault exception includes a memory page fault exception and a memory mapping page fault exception;
for the memory page fault exception, the simulator maps the memory page to a virtual machine address to simulate the behaviors of the hardware modules;
for the memory mapping page fault exception, the simulator simulates the behaviors of the hardware modules according to a type of the operation instruction, including:
if the operation instruction is a read operation, the simulator feeds back read data to the virtual machine; and
if the operation instruction is a write operation, the simulator simulates the behavior of the hardware modules on the write operation.
